(19) United States
(12) Patent Application Publication
(10) Pub. No.: US 2009/0196438 A1
(43) Pub. Date: Aug. 6, 2009

(54) MULTIMEDIA PROCESSOR CHIP AND METHOD FOR PROCESSING AUDIO SIGNALS

(75) Inventors: Jong-Sik JEONG, Seoul (KR); Yun-Hyoung Jeong, Seoul (KR)

Correspondence Address: BIRCH STEWART KOLASCH & BIRCH, PO BOX 747, FALLS CHURCH, VA, 22040-0747, US

(73) Assignee: MTEKVISION CO., LTD., Seoul (KR)

(21) Appl. No.: 12/361,082

(22) Filed: Jan. 28, 2009

(30) Foreign Application Priority Data
Jan. 29, 2008 (KR) 10-2008-0008836

(51) Int. Cl. H04B 1/00

(52) U.S. Cl. 381/119

(57) ABSTRACT

A multimedia processor chip includes: a first re-sampler converting a sample rate of a decoded first audio signal into a first sample rate and outputting the converted first audio signal to a first output buffer; a second re-sampler converting a sample rate of a decoded second audio signal into the first sample rate and outputting the converted second audio signal to a second output buffer; and a mixer mixing the audio signals input from the first output buffer and the second output buffer and outputting the mixed audio signals to an audio converter through a communication unit. Accordingly, it is possible to reduce a processing load of a multimedia processor core to permit a low-power operation and to easily accomplish various audio effects.

### CROSS-REFERENCE TO RELATED APPLICATIONS

This application claims the benefit of Korean Patent Application No. 10-2008-0008836 filed with the Korean Intellectual Property Office on Jan. 29, 2008, the disclosures of which are incorporated herein by reference in their entirety.

### BACKGROUND

1. Field of the Invention

The present invention relates to audio signal processing, and more particularly, to a multimedia processor chip and an audio signal processing method.

2. Related Art

As known well, hand-held digital audio systems are spread widely. The systems include digital audio players and recorders storing MP3 files, WMA files, and the like and then reproducing the files. The digital audio players and recorders may be used as digital recorders or file transmitting devices and may include a frequency modulated radio receiver and a DMB receiver.

Examples of the hand-held digital audio systems can include electronic apparatuses such as MP3 players exclusively used as an audio player and recorder and mobile communication terminals and hand-held video player and recorders having the function of an audio player and recorder as a secondary function.

A multimedia processor chip included in the hand-held digital audio systems has one audio interface port and operates in cooperation with an audio conversion chip via the audio interface port. The audio conversion chip serves to convert audio signals input from the multimedia processor chip into analog signals and to output the analog signals through a speaker and serves to convert audio signals input from a microphone into digital signals and to input the digital signals to the multimedia processor chip.

However, since the hand-held digital audio systems have only one audio interface port, many inconveniences are caused in mixing two or more audio signals or performing a recording operation while outputting audio signals.

In addition, since a multimedia processor core (CPU) of the multimedia processor chip should perform many operations, it is difficult to embody the multimedia processor chip with low power.

### SUMMARY

An advantage of some aspects of the invention is that it provides a multimedia processor chip and an audio signal processing method that can reduce an operation clock of a multimedia processor core to permit a lower-power operation by reducing a processing load of the multimedia processor core (CPU).

Another advantage of some aspects of the invention is that it provides a multimedia processor chip and an audio signal processing method that can easily mix plural audio signals having different sample rates to accomplish various audio effects.

According to an aspect of the invention, there is provided a multimedia processor chip including: a first re-sampler converting a sample rate of a decoded first audio signal into a first sample rate and outputting the converted first audio signal to a first output buffer; a second re-sampler converting a sample rate of a decoded second audio signal into the first sample rate and outputting the converted second audio signal to a second output buffer; and a mixer mixing the audio signals input from the first output buffer and the second output buffer and outputting the mixed audio signals to an audio converter through a communication unit.

The multimedia processor chip may further include an input buffer temporarily storing the audio signal input from the audio converter through the communication unit and a third re-sampler converting the sample rate of the audio signal output from the input buffer into a second sample rate.

The first sample rate and the second sample rate may be equal to or different from each other.

The mixer may start mixing audio signals when the audio signals are input from the first output buffer and the second output buffer.

The audio converter may be coupled to a speaker outputting an audio signal and a microphone receiving an audio signal.

In the multimedia processor chip, the communication unit and the audio converter may be coupled to each other through two channels. Here, the communication unit may include a first communication unit outputting the audio signal input from the mixer to the audio converter through a first channel and a second communication unit receiving the audio signal from the audio converter through a second channel.

According to another aspect of the invention, there is provided a multimedia processor chip including: a first re-sampler converting a sample rate of a decoded audio signal into a first sample rate and outputting the converted audio signal to a first output buffer; a first communication unit outputting the audio signal input from the first output buffer to an audio converter; a second communication unit outputting an audio signal input from the audio converter to an input buffer; and a second re-sampler converting a sample rate of the audio signal input from the input buffer into a second sample rate and outputting the converted audio signal. Here, the first communication unit and the second communication unit are connected to the audio converter through independent channels.

The multimedia processor chip may further include a third re-sampler converting a sample rate of a decoded audio signal into a first sample rate and outputting the converted audio signal to a second output buffer and a mixer mixing the audio signals input from the first output buffer and the second output buffer and outputting the mixed audio signals to the first communication unit.

The mixer may start mixing audio signals when the audio signals are input from the first output buffer and the second output buffer.

The first sample rate and the second sample rate may be equal to each other.

The audio converter may be coupled to a speaker outputting an audio signal and a microphone receiving an audio signal.

According to the aspects of the invention, it is possible to reduce an operation clock of a multimedia processor core to permit a lower-power operation, by reducing a processing load of the multimedia processor core (CPU).

According to the aspects of the invention, it is also possible to easily mix plural audio signals having different sample rates, thereby accomplishing various audio effects.

### BRIEF DESCRIPTION OF THE DRAWINGS

FIG. 1 is a diagram illustrating a configuration of a known multimedia processor chip.

FIG. 2 is a diagram illustrating a configuration of a known input and output buffer unit.

FIG. 3 is a diagram illustrating a configuration of an input and output buffer unit according to an embodiment of the invention.

FIG. 4 is a diagram illustrating a configuration of a multimedia processor chip according to another embodiment of the invention.

FIG. 5 is a diagram illustrating a configuration an input and output buffer and communication unit according to the embodiment of the invention.

FIG. 6 is a diagram illustrating a configuration of an input and output buffer and communication unit according to another embodiment of the invention.

### DESCRIPTION OF EXEMPLARY EMBODIMENTS

The invention can be variously modified in various embodiments and specific embodiments will be described and shown in the drawings. The invention is not limited to the embodiments, but it should be understood that the invention includes all the modifications, equivalents, and replacements belonging to the spirit and the technical scope of the invention. When it is determined that detailed description of known techniques associated with the invention makes the gist of the invention obscure, the detailed description will be omitted.

Terms, “first”, “second”, and the like, can be used to describe various elements, but the elements are not limited to the terms. The terms are used only to distinguish one element from another element.

The terms used in the following description are used to merely describe specific embodiments, but are not intended to limit the invention. An expression of the singular number includes an expression of the plural number, so long as it is clearly read differently. The terms such as “include”, “have”, and the like are intended to indicate that features, numbers, steps, operations, elements, components, or combinations thereof used in the following description exist and that the possibility of existence or addition of one or more different features, numbers, steps, operations, elements, components, or combinations thereof is not excluded.

Hereinafter, exemplary embodiments of the invention will be described in detail with reference to the accompanying drawings. A mobile communication terminal mounted with a multimedia processor chip will be described mainly, but it is obvious that the invention is not limited to the mobile communication terminal but can be applied to all digital processing devices that can be mounted with a multimedia chip.

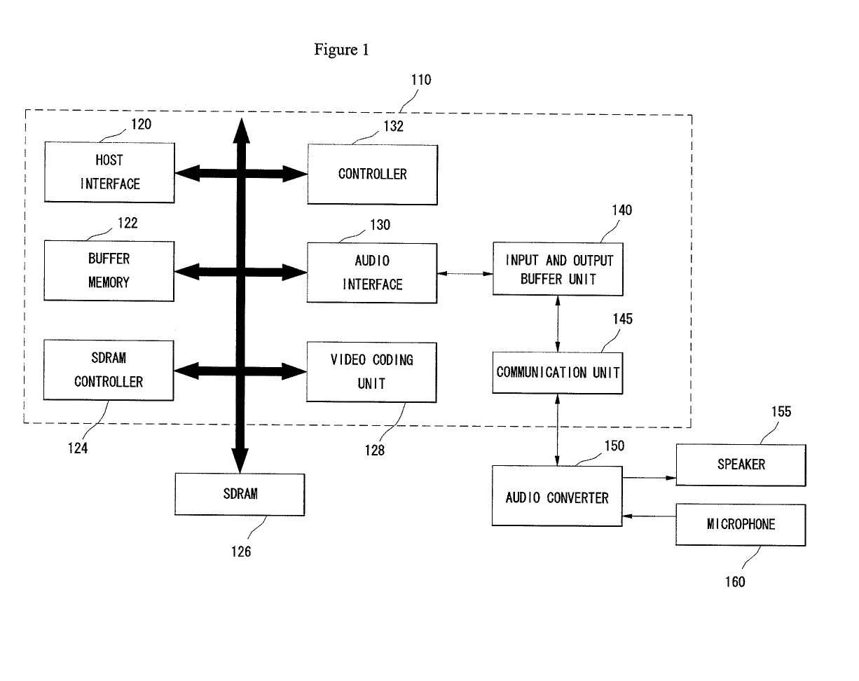

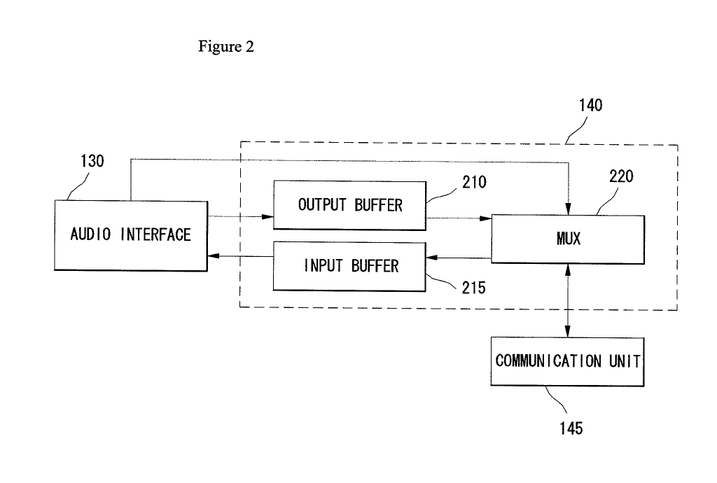

FIG. 1 is a diagram illustrating a configuration of a known multimedia processor chip and FIG. 2 is a diagram illustrating a configuration of a known input and output buffer unit.

Referring to FIG. 1, a multimedia processor chip 110 mounted on a mobile communication terminal includes a host interface 120, a buffer memory 122, an SDRAM controller 124, a video coding unit 128, an audio interface 130, a controller 132, an input and output buffer unit 140, and a communication unit 145.

The host interface 120 serves to communicate with a main processor chip (not shown) mounted in the mobile communication terminal. In general, plural processor chips are mounted on a mobile communication terminal. This is because the mobile communication terminal needs to be mounted with secondary processor chips performing secondary functions such as a multimedia data reproduction function and a navigation function, as well as the main processor chip performing a radio communication function and comprehensively controlling the mobile communication terminal. The multimedia processor chip may be a kind of secondary processor chip reproducing and outputting multimedia data or processing audio signals input from a microphone.

The buffer memory 122 is a storage space temporarily storing data to be processed by the multimedia processor chip 110.

The SDRAM controller 124 serves to control an SDRAM 126 coupled to the multimedia processor chip 110. The SDRAM 126 is a storage space storing data processed by the multimedia processor chip 110 or data to be processed by the multimedia processor chip 110. It is obvious to those skilled in the art that the storage space coupled to the multimedia processor chip 110 is not limited to the SDRAM.

The video coding unit 128 serves to perform an imaging process of decoding and outputting video data to be output through a display device (for example, a liquid crystal screen) or encoding input data (for example, image data input through an image sensor or the like) and storing the encoded data in the SDRAM 126.

The audio interface 130 serves to transmit audio signals to the audio converter 150 and to output the converted audio signals through a speaker 155 or serves to receive audio signals input through the microphone 160 from the audio converter 150. The audio interface 130 may have an audio processing function of decoding and outputting audio signals to the audio converter 150 and encoding the audio signals input from the audio converter 150. The audio processing function may be performed by the controller 132.

The audio converter 150 converts the audio signals input from the audio interface 130 into analog signals and outputs the analog signals through the speaker 155. The audio converter 150 also converts the audio signals input through the microphone 160 into digital signals and transmits the digital signal to the audio interface 130.

The controller 132 directly or indirectly controls the constituent elements of the multimedia processor chip 110 to perform specified functions. The controller 132 is, for example, a CPU processor. The controller 132 may perform the audio processing function of encoding and decoding audio signals and the like.

The input and output buffer unit 140 transmits the audio signals input from the audio converter 150 to the audio interface 130 or transmits the audio signals input from the audio interface 130 to the audio converter 150.

The detailed configuration of the input and output buffer unit 140 according to the related art is shown in FIG. 2.

Referring to FIG. 2, the input and output buffer unit 140 includes an output buffer 210, an input buffer 215, and a MUX (multiplexer) 220.

The output buffer 210 is a storage medium temporarily storing and outputting the audio signals (that is, the audio signals decoded by the controller 132 or the audio interface 130) input from the audio interface 130. The input buffer 215 is a storage medium temporarily storing and outputting the audio signals input from the audio converter 150. When necessary data is stored in the input buffer 215, the stored data is transmitted to the audio interface 130 (or is stored in the buffer memory 122). The controller 132 receiving a notification from the audio interface 130 performs necessary operations. When the audio interface 130 has the audio processing function, the necessary operations may be performed by the audio interface 130.

The MUX 220 forms a data transmission path under the control of the audio interface 130. For example, when an audio signal is input from the output buffer 210 and an audio signal is input from the audio converter 150, only one audio signal is transmitted to a receiving side under the control of the audio interface 130. Since the controller 132 can know what the current operation of the mobile communication terminal is, the controller 132 can know what audio signal the MUX 220 should transmit to the receiving side and allows the audio interface 130 to control the MUX with reference to the knowledge. For example, when the mobile communication terminal is performing an MP3 data reproducing function, the MUX 220 is controlled to transmit the data stored in the output buffer 210 to the audio converter 150.

The communication unit 145 transmits and receives audio signals to and from the audio converter 150 through one port in a serial manner.

As described above, the known multimedia processor chip cannot mix two or more audio signals and is coupled to the audio converter 150 through only one port. Accordingly, the known multimedia processor chip has a structural restriction that it cannot perform the output and the recording of an audio signal at the same time.

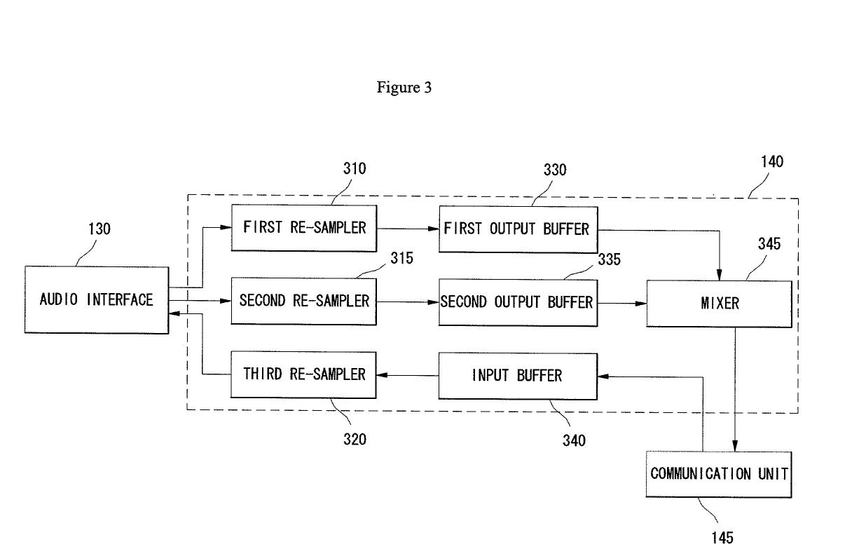

FIG. 3 is a diagram illustrating a configuration of an input and output buffer unit according to an embodiment of the invention. The multimedia processor chip 110 can be embodied similarly to the configuration shown in FIG. 1 except for the configuration of the input and output buffer unit 140 and thus description thereof is omitted.

Referring to FIG. 3, the input and output buffer unit 140 includes a first re-sampler 310, a second re-sampler 320, a third re-sampler 320, a first output buffer 330, a second output buffer 335, an input buffer 340, and a mixer 345.

An audio signal is basically sampled at a sampling frequency determined at the time of converting an analog signal into a digital signal. Accordingly, when the audio signal is reproduced at a frequency other than the original sampling frequency, its sound is different from the original sound and the reproduction speed is also different that of the original sound. That is, a sample rate is a sampling rate unit of a sound exhibited for 1 second at the time of converting an analog signal into a digital signal. As the value of the sample rate is higher, the sound gets closer to the original sound.

The first re-sampler 310 and the second re-sampler 315 perform a function of setting sample rates of two audio signals to be mixed to be equal to each other.

The first output buffer 330 temporarily stores data re-sampled by the first re-sampler 310 and then outputs the re-sampled data to the mixer 345. The second output buffer 335 temporarily stores data re-sampled by the second re-sampler 315 and then output the re-sampled data to the mixer 345.

The first re-sampler 310, the first output buffer 330, the second re-sampler 315, and the second output buffer 335 may not operate in all the cases. That is, when two or more audio signals need not be mixed and output, only one output path of an output path of the first re-sampler 310 and the first output buffer 330 and an output path of the re-sampler 315 and the second output buffer 335 can be used. When three or more audio signals need be mixed, it is obvious that a third re-sampler (not shown) and a third output buffer (not shown) may be further added.

A procedure of allowing the multimedia processor chip 110 to output two or more audio signals to the communication unit 145 will be described in brief now. For example, the controller 132 decodes and stores an audio signal having a sample rate of 64 fs in the buffer memory 122 and decodes and stores an audio signal having a sample rate of 32 fs in the buffer memory 122. Thereafter, the controller 132 controls the audio interface 130 to read the audio signals (that is, audio data), to transmit the read audio signals to the first re-sampler 310 and the second re-sampler 315, respectively, to re-sample the audio signals at 64 fs. The re-sampled audio signals are input to the corresponding output buffers and are output to the mixer 345. The mixer 345 mixes the input audio signals and then outputs the mixed audio signals to the communication unit 145.

That is, the controller 132 decodes two audio signals with a time interval interposed therebetween, stores the decoded audio signals in the output buffers, respectively, and outputs the audio data stored in the output buffer at the same time.

The controller 132 or the audio interface 130 can recognize whether data to be output is all stored in the output buffers and instruct the output buffers to output data or instruct the mixer 345 to start reading data. Alternatively, when the output buffers are instructed to output data at the time of completion of accumulation of data, the mixer recognizing that it is necessary to mix audio signals (for example, recognizing it on the basis of a control signal transmitted from the controller 132 or the audio interface 130) may start the mixing at the time point that data is input from all the output buffers.

The data stored in the output buffers can be output in an FIFO manner and the amount of data output from the output buffers per unit time can be restricted to be equal to each other.

The input buffer 340 temporarily stores the audio signals input through the communication unit 145 and then outputs the audio signals to the third re-sampler 320.

The third re-sampler 320 serves to convert the sample rate of the input audio signal into a specified sample rate. The sample rates specified in the first re-sampler 310, the second re-sampler 315, and the third re-sampler 320 may be equal or different if necessary.

For example, when the audio signal input from the microphone 160 is mixed with the audio signal decoded by the controller 132 and the mixed audio signals are recorded, the sample rates thereof can be specified equal to each other.

By specifying the sample rate of the audio signal decoded by the controller 132 to be different at the time of mixing the audio signal input from the microphone 160 with the audio signal decoded by the controller 132, various effects can be exhibited when the same sound source is used as background music.

As described above, two or more audio signals as source data mixed by the mixer 345 may be data stored in advance in the mobile communication terminal and the audio signal input in real time from the microphone 160 may be used along with the data stored in advance. In the latter, the audio signal input in real time and output through the input buffer may be provided to the mixer 345 through the output buffer again.

Similarly, when two or more input buffers are provided, the audio mixing operation may be performed using only different source audio data (for example, a user's voice and an output of an acoustic apparatus) or the audio mixing operation may be performed using various source audio signals input in real time along with the data stored in advance.

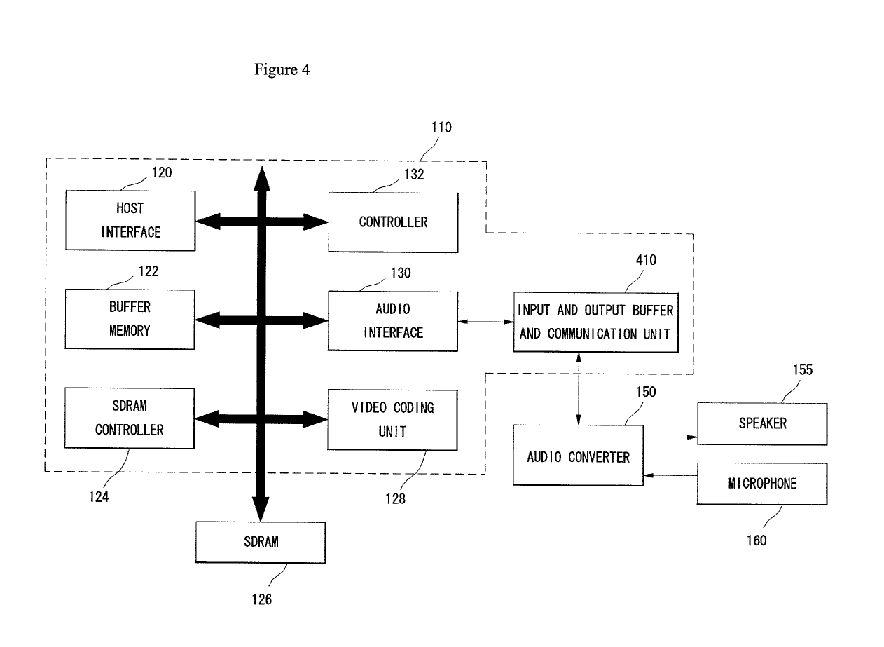

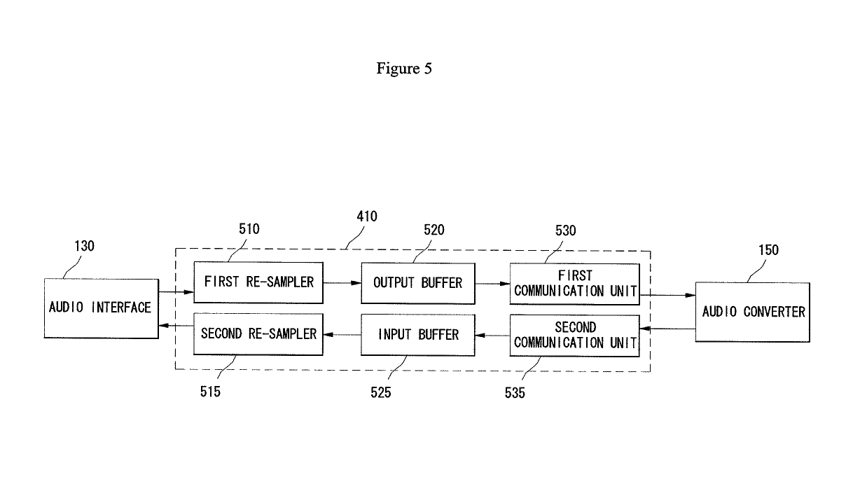

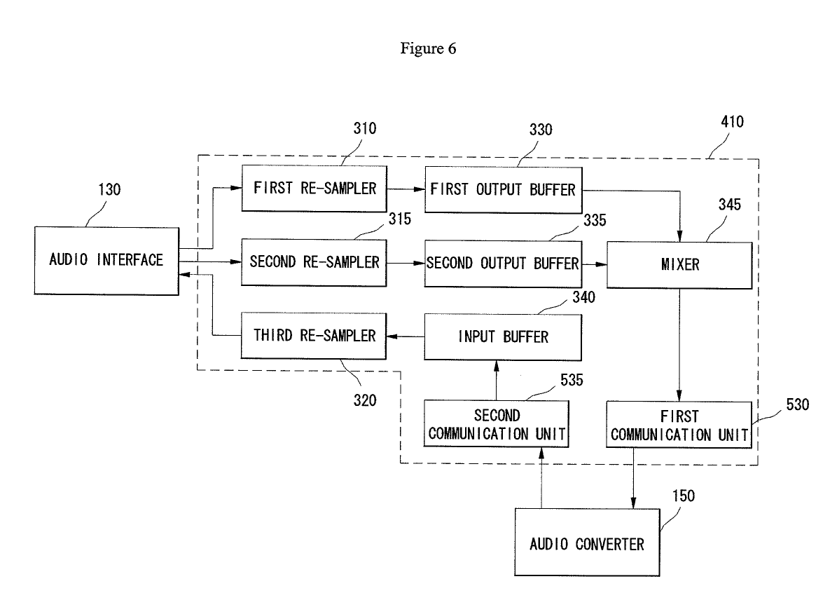

FIG. 4 is a diagram illustrating a configuration of a multimedia processor chip according to another embodiment of the invention. FIG. 5 is a diagram illustrating a configuration of an input and output buffer and communication unit according to another embodiment of the invention. FIG. 6 is a diagram illustrating a configuration of an input and output buffer and communication unit according to another embodiment of the invention.

Referring to FIG. 4, the multimedia processor chip 110 mounted on the mobile communication terminal includes a host interface 120, a buffer memory 122, an SDRAM controller 124, a video coding unit 128, an audio interface 130, a controller 132, and an input and output buffer and communication unit 410.

Most elements shown in FIG. 4 are the same as described with reference to FIG. 1 and thus description thereof is omitted. Accordingly, only the input and output buffer and communication unit 410 will be described with reference to FIGS. 5 and 6.

Referring to FIG. 5, the input and output buffer and communication unit 410 includes a first re-sampler 510, a second re-sampler 515, an output buffer 520, an input buffer 525, a first communication unit 530, and a second communication unit 535.

The first re-sampler 510 converts the sample rate of an audio signal into a specified sample rate and outputs the converted audio signal to the audio converter 150. The audio signal converted by the first re-sampler 510 is temporarily stored in the output buffer 520 and then is input to the audio converter 150 through the first communication unit 530. The first communication unit 530 transmits the audio signal to the audio converter 150 in a serial communication manner.

The input buffer 525 temporarily stores an audio signal input from the second communication unit 535 and the audio converter 150 and then outputs the audio signal to the second re-sampler 515. The second re-sampler 515 converts the sample rate of an audio signal input from the input buffer 525 into a predetermined sample rate and outputs the converted audio signal to the audio interface 130.

As described above, the input and output buffer and communication unit 410 and the audio converter 150 are coupled to each other through two channels in which an input line and an output line are independently embodied. Accordingly, when the audio converter 150 specifies different sample rates for the input and the output, the maximum effect can be exhibited. For example, since an audio signal having a sample rate of 64 fs can be output and an audio signal having a sample rate of 32 fs can be received as an input, this configuration can be more easily embodied in applications than the configuration having a single serial port.

Referring to FIG. 6, the input and output buffer and communication unit 410 includes a first re-sampler 310, a second re-sampler 315, a third re-sampler 320, a first output buffer 330, a second output buffer 335, an input buffer 340, a first communication unit 530, and a second communication unit 535.

That is, since the example shown in FIG. 6 as described with reference to FIG. 4 include plural re-samplers, plural output buffers, and a mixer, it is possible to easily mix plural audio signals and to easily convert the sample rates of the audio signals to be mixed.

Since the input and output buffer and communication unit 410 and the audio converter 150 are coupled to each other through two channels in which an input line and an output line are independently embodied, it is possible to easily input and output the audio signals having different sample rates.

The above-mentioned audio signal processing method can be embodied by a computer program. Codes and segments of the program can be easily made by computer programmers skilled in the art. The program can be stored in a computer-readable storage medium and can be read and executed by a computer to embody the audio signal processing method. The storage medium can include a magnetic recording medium, an optical recording medium, and a carrier wave medium.

Although the invention has been described with reference to the exemplary embodiments, it will be understood by those skilled in the art that the invention can be modified and changed in various forms without departing from the spirit and scope of the invention described in the appended claims.

What is claimed is:

1. A multimedia processor chip comprising:
a first re-sampler converting a sample rate of a decoded first audio signal into a first sample rate and outputting the converted first audio signal to a first output buffer;
a second re-sampler converting a sample rate of a decoded second audio signal into the first sample rate and outputting the converted second audio signal to a second output buffer; and
a mixer mixing the audio signals input from the first output buffer and the second output buffer and outputting the mixed audio signals to an audio converter through a communication unit.

2. The multimedia processor chip according to claim 1, further comprising:
an input buffer temporarily storing the audio signal input from the audio converter through the communication unit; and
a third re-sampler converting the sample rate of the audio signal output from the input buffer into a second sample rate.

3. The multimedia processor according to claim 2, wherein the first sample rate and the second sample rate are equal to each other.

4. The multimedia processor chip according to claim 2, wherein the communication unit and the audio converter are coupled to each other through two channels, and
wherein the communication unit includes a first communication unit outputting the audio signal input from the mixer to the audio converter through a first channel and a second communication unit receiving the audio signal from the audio converter through a second channel.

5. A multimedia processor chip comprising:
a first re-sampler converting a sample rate of a decoded audio signal into a first sample rate and outputting the converted audio signal to a first output buffer;
a first communication unit outputting the audio signal input from the first output buffer to an audio converter;
a second communication unit outputting an audio signal input from the audio converter to an input buffer; and
a second re-sampler converting a sample rate of the audio signal input from the input buffer into a second sample rate and outputting the converted audio signal,
wherein the first communication unit and the second communication unit are connected to the audio converter through independent channels.

6. The multimedia processor chip according to claim 5, further comprising:
a third re-sampler converting a sample rate of a decoded audio signal into a first sample rate and outputting the converted audio signal to a second output buffer; and
a mixer mixing the audio signals input from the first output buffer and the second output buffer and outputting the mixed audio signals to the first communication unit.

7. The multimedia processor chip according to claim 5, wherein the first sample rate and the second sample rate are equal to each other.
